(19) United States
(12) Patent Application Publication
(10) Pub. No.: US 2011/0022870 A1
(43) Pub. Date: Jan. 27, 2011

(54) COMPONENT POWER MONITORING AND WORKLOAD OPTIMIZATION

(75) Inventors: Sean N. McGrane, Sammamish, WA (US); Stephen R. Berard, Seattle, WA (US); Bruce L. Worthington, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/506,687

(22) Filed: Jul. 21, 2009

(51) Int. Cl. G06F 11/30; G06F 1/26

(52) U.S. Cl. 713/340; 718/104

(57) ABSTRACT

A component level power monitoring system may analyze workloads by determining energy consumed by individual components for the workload. By comparing different system configurations or by modifying the software operation, an optimized workload may be performed per energy consumed. In some embodiments, several system configurations may be attempted to determine an optimized system configuration. In other embodiments, a monitoring system may change how an application is executed by changing thread affinity or otherwise assigning certain operations to specific components. The component level monitoring may be implemented as operating system level function calls.

### BACKGROUND

Computing devices consume electric energy as various components of the computing devices are used. In many cases, the workload of the computing devices may affect how much energy is consumed. For example, processors that are heavily utilized can consume much more energy than processors that are idle or lightly utilized.

In datacenter environments, a large number of server computers may perform various workloads. In many cases, a datacenter may have many different types of hardware and different workloads. Datacenters can consume very large amounts of energy and generate large amounts of heat. In many cases, datacenter managers may use virtualization technologies to manage workloads. Virtualization technology may be virtual applications or virtual machines that may be moved from one hardware device to another to consolidate or expand capabilities.

### SUMMARY

A component level power monitoring system may analyze workloads by determining energy consumed by individual components for the workload. By comparing different system configurations or by modifying the software operation, an optimized workload may be performed per energy consumed. In some embodiments, several system configurations may be attempted to determine an optimized system configuration. In other embodiments, a monitoring system may change how an application is executed by changing thread affinity or otherwise assigning certain operations to specific components. The component level monitoring may be implemented as operating system level function calls.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a device with a workload manager.

FIG. 2 is a diagram illustration of an embodiment showing a workload manager in a network environment.

FIG. 3 is a flowchart illustration of an embodiment showing a method for optimizing configurations for a workload.

FIG. 4 is a flowchart illustration of an embodiment showing a method for monitoring workload efficiency.

FIG. 5 is a flowchart illustration of an embodiment showing a method for using efficiency when operating workloads.

### DETAILED DESCRIPTION

Computer workloads may be analyzed by monitoring various components of a computer hardware system and determining a measurement of efficiency based on the amount of work performed from an amount of energy consumed. For a given workload, the energy consumption may be defined in a function, data structure, or other mechanism so that comparison of system configurations may be performed. The comparisons may identify those configurations for which the workload may be operated at high efficiencies.

A hardware device may be instrumented with various power sensing components. In some embodiments, operating system level functions may collect energy consumption data that may be used by monitoring or optimization software applications. The components that may be instrumented may include processor and memory components, bridges, fans, power supplies, as well as peripheral devices, embedded controllers, and other components.

In some embodiments, an optimization process may involve evaluating a workload on two or more different system configurations, then selecting a more efficient system configuration. Some embodiments may configure a single hardware platform in different configurations, such as operating a workload on one or more different processors or with different peripheral devices, for example. Other embodiments may evaluate different hardware platforms with different configurations, such as may be performed when managing a datacenter environment where virtual machines or other workloads may be moved from one server computer to another.

Throughout this specification, the notion of efficiency refers to unit of work performed per unit of energy The unit of work may be defined differently for various workloads. For example, some workloads may be processor intensive and involve large amounts of computations. In such a workload, the unit of work may be measured by the number of computations performed. In the example, an efficient system configuration may perform the most computations for the lowest energy consumed. The most efficient system configuration may not be the fastest system configuration.

In another example, a workload may process messages, such as an email distribution system. In such an example, the unit of work for the workload may be the number of messages processed, and the efficiency may be expressed as number of messages processed per unit of energy.

The term “power” refers to the rate at which energy is consumed. Some embodiments may express power in energy per given unit of time. In some embodiments, power may be determined by instantaneous measurements or by computing the energy consumed over a period of time and dividing that value by the period of time.

While different embodiments may calculate energy and power in different manners, many devices that measure power consumption may use the unit Watts, and may do so by multiplying an instantaneous current measurement for direct current in Amperes and the voltage in Volts. The term “energy” may be the power integrated over time. For example, energy in Kilowatt-Hours is the average power in Watts measured over a period of time multiplied by the length of time, in this case measured in Hours. Other embodiments may use other methods to determine energy or power consumption, including alternating current embodiments that may use expressions for power factor, among others.

In some embodiments, power may be directly measured and energy may be estimated or calculated from multiple instantaneous measurements. In other embodiments, energy may be measured directly and power may be calculated. In some embodiments, certain components may measure power directly while other components may measure energy directly. In still other embodiments, energy or power may be measured indirectly, such as measuring temperature or other parameters from which energy or power may be calculated.

The overall energy consumed by the device may be determined at least in part by summing the energy consumed by the various components. In some embodiments, the overall energy may be determined by adding the energy consumed by each individual component. In other embodiments, a function or other mechanism may be used to calculate overall energy and such a mechanism may include input from each of the measured energy consumed by individual components.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

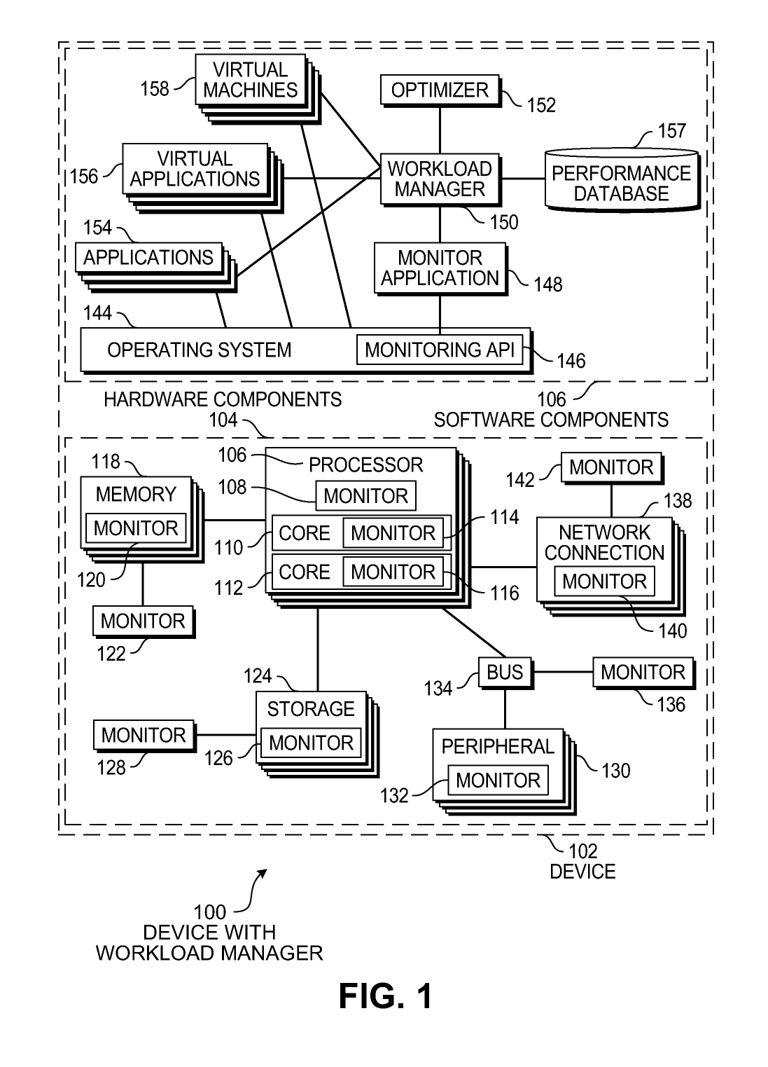

FIG. 1 is a diagram of an embodiment 100 showing a system with a workload management system. Embodiment 100 is a simplified example of a system that may monitor hardware components for power and identify optimal system configurations using the energy consumption.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning arbitrary long distances. Each embodiment may use different hardware, software, and interconnection architectures to achieve the functions described.

Embodiment 100 is an example of an instrumented device that may be capable of monitoring energy consumption by various hardware components. The energy consumption may be evaluated for a workload and an optimized system configuration may be determined for the workload.

The mechanisms for monitoring power or energy consumption at a component level may be used for optimizing the workload efficiency of a single device, such as in embodiment 100, or for selecting an efficient device on which to execute a workload, as illustrated in embodiment 200 presented later in this specification. Embodiment 100 may be useful in situations where a device can be configured in different manners to operate a workload. Embodiment 200 may be useful in datacenters or other environments where several different hardware platforms or devices may execute a workload.

An optimized workload efficiency may be determined by executing a workload on two or more different system configurations, then determining an optimal system configuration based on the energy consumption measured during execution on each system configuration.

In some cases, an optimized workload efficiency may be selected by comparing the efficiencies observed on several system configurations and selecting the system configuration with the highest efficiency. In other cases, an optimized workload efficiency may be determined by selecting certain hardware components or settings for various system components that may yield an efficient workload. In such cases, the selected system configuration may be one that was not previously tested.

In general, workload efficiency may be a function of work performed by the energy consumed. Different embodiments may have different functions that may be used to describe workload efficiency, and may use various data structures, functions, parameters, or other mechanisms for describing the efficiency and comparing efficiencies.

A workload, for the purposes of this specification and claims, may be any software component or system that may be executed on a hardware platform. In some cases, the workload may be a single thread or process that performs a specific function. In other cases, the workload may be a multithreaded collection of processes that operate as a computer application. Some workloads may be virtualized components, such as virtual applications and virtual machines. In some cases, a workload may encompass all of the software operating on a device, which may include an operating system, applications, and various other components.

Each workload may have a unit of work performed by the workload. The unit of work may be used to determine an efficiency of the workload. In some embodiments, each workload may be measured in a generic sense by monitoring the number of computations performed by the workload. In such embodiments, the number of computations may be a general parameter that expresses or approximates the amount of work performed. Such a parameter may be useful in measuring efficiency for any workload. A measure of efficiency may be the number of computations performed per unit of energy.

In other embodiments, the workload may lend itself to other measures of work. For example, a workload that performs optical character recognition may measure a unit of work as the number of characters evaluated or the number of pages scanned. In such a case, an efficiency metric may be calculated by dividing the number of pages scanned by the energy consumed.

In another example, some workloads respond to requests, and in such cases, the requests may be a measure of work performed. Examples may include a database application that responds to queries or a web server that responds to browser requests. In such cases, an efficiency metric may be calculated by dividing the number of requests by the energy consumed.

In many cases, the efficiency of a system may be a function of many different interacting components. For example, a processor operated in a high speed but high power consuming mode may have a high efficiency when coupled with a high speed storage device because a large amount of work may be performed per unit of energy. The same hardware may be configured to operate the processor in a low power mode, and may or may not be more efficient when coupled to the same high speed storage device.

In some embodiments, the measure of efficiency may be evaluated by calculating the efficiency of individual components and summing the efficiencies. In many such embodiments, the overall efficiency may be expressed as a function of several separate component efficiencies. In the example above, the overall efficiency of a system may include an efficiency metric for a processor and a separate efficiency metric for a storage device.

In some embodiments, an optimization routine may compare efficiency expressions for different system configurations and create an optimized system configuration. In some such embodiments, the efficiencies of different components may be compared to identify an optimized system configuration for maximum or optimized efficiency. In some embodiments, the optimized system configuration may merely be determined by selecting a tested system configuration that has the highest calculated efficiency. In other embodiments, the optimized system configuration may be determined by selecting components or configurations of components based on component-level efficiency. In such embodiments, the optimized system configuration may be a system configuration that was not previously tested.

A system configuration, for the purposes of this specification and claims, is the arrangement of anything changeable other than the workload being executed. When running a workload on different system configurations, the workload may comprise executable instructions that are not changed between different system configurations.

The system configuration may be the environment in which the workload is executed. The environment may include hardware, software, firmware, or other differences between systems. In some cases, different system configurations may have different physical hardware components, such as different processors or data storage devices. In some cases, different system configurations may be different settings or configurations of the same physical components, such as software or firmware settings that cause a device to operate in a certain manner, enable or disable certain features, operate in a low power mode, or other configuration settings. Such configuration settings may be changes to software, firmware, BIOS, registry entries, data registers, or other configuration

In some embodiments, the system configuration may include configuration changes to software that operates on a system in addition to the workload. For example, a workload may execute within an operating system environment, such as an application. Another example may be a virtual machine workload that executes within a virtual machine host environment. Changes to the virtual machine host or settings on the virtual machine may cause the workload to execute with different efficiencies.

Embodiment 100 illustrates a device 102 that may have instrumentation capable of monitoring power or energy consumption for various components. The instrumentation for a component may be embedded in a component or external to the component, and may be used for monitoring power or energy consumption.

The hardware components 104 of the device 102 may include a processor 106. The processor 106 may execute instructions to perform various functions. Some embodiments, as illustrated in device 102, may have multiple processors, and each processor may have multiple processor cores. Some embodiments, such as server computers, may have multiple processors each with multiple processor cores.

As illustrated, the processor 106 may be a processor that has dual cores 110 and 112. Some embodiments of a multicore processor 106 may have a monitor 108 that may be capable of tracking power or energy consumption of the entire processor 106. In some such embodiments, the energy power consumed by each individual core 110 or 112 may not be tracked. Other embodiments may enable the monitor 108 to track power by each core 110 and 112 separately. In some embodiments, each processor core 110 and 112 may have separate monitors 114 and 116.

Some embodiments may have multiple processors or cores that are not identical and may be considered heterogeneous. For example, a processor may contain two cores, one with a faster speed and one with a slower speed. Another example may be a device that has a processor with certain capabilities and performance characteristics and a second processor with different capabilities and performance characteristics. In such examples, a workload may be executed on each processor or core and the power or energy consumption may be monitored. An optimized system configuration may include the processor that executes the workload with the lowest power consumed. In some cases, a slower processor may execute a workload with more efficiency, while in other cases a faster processor may be more efficient.

In some embodiments, processors and other components may be configurable to operate in different manners. For example, some processors may be configured to operate at different processor frequencies. When operated at higher frequencies, a processor may consume more energy but perform more calculations. Similarly, a processor may be operated at a lower frequency and consume less energy but perform fewer calculations.

In some such embodiments, a system configuration may assign certain processes or software threads to specific processors. For example, a computation-heavy software thread may be configured to operate on a processor set to operate at a high frequency, while another software thread may be configured to operate on a different processor that is set to operate at a low frequency. A software thread may be a set of sequential tasks or executable instructions which are executed as a group. In many cases, a single application or process may have several threads, each of which may be executed in parallel using different processors or through time division multiplexing when two or more threads are executed on the same processor.

The hardware components 104 may include memory 118, which may be random access memory used by the processors 106. Random access memory may be high speed memory that is used to store executable commands and data created by or used by the processors 106. In some embodiments, the memory 118 may be volatile memory. The memory 118 may be made up of several subcomponents. For example, personal computer and server computer systems often are configured with 2, 4, 8, or any number of memory components. One example of such a memory component may be a Dual Inline Memory Module (DIMM).

The memory 118 may have internal monitors 120 that may monitor and report power or energy consumption by the individual device. In some cases, a separate or external monitor 122 may monitor the power or energy consumption of the memory 118 as a whole or as individual subcomponents.

In some embodiments, certain memory subcomponents may have different performance characteristics. For example, a user may upgrade the memory 118 on device 102 by populating previously unpopulated memory slots. The newly added memory may be newer versions of memory 118 and may have different performance characteristics and different power or energy consumption.

Storage 124 may be devices used to store applications and data and may be nonvolatile memory. The storage 124 may be accessed by the processor 106 to load executable software and store data during execution. Typically, the storage 124 may be much slower performance than the memory 118. Examples of storage 124 may be hard disk drives, solid state memory devices, tape storage systems, and other storage devices.

Similar to the memory 118, the storage 124 may have individual monitors 126 for individual subcomponents or a separate monitor 128. The separate monitor 128 may measure the power or energy usage for the storage 124 components as a group, or may be able to measure the power or energy usage of individual storage 124 components.

Computing devices have many different types of architectures. In some devices designed for expansion or for manufacturing with different options, the architecture may include a bus 134 through which different peripherals 130 may be attached. In some cases, the peripherals 130 may have a printed circuit board or other connection to the bus 134.

In some embodiments, the bus 134 may be internal to a computing device, such as a PCI, PCI-X, ISA, EISA, or many other types of standardized printed circuit board interface to a computing motherboard.

In some embodiments, the bus 134 may be external to a computing device. In such a configuration, peripherals 130 may connect using busses such as Universal Serial Bus, Small Computer System Interface (SCSI), PCMCIA, or other connections.

The peripherals 130 may be any type of component that may be added to a computer device. In some cases, the peripherals 130 may be integral to allowing the device 102 to operate, such as peripherals 130 that may include bootable storage 124 devices. The peripherals 130 may be input and output devices such as cameras, video displays, keyboards, pointing devices, audio input or output devices, printers, scanners, or other devices. In some cases, the peripherals 130 may include connections to other computer devices, and may include network connections 138.

In some embodiments, individual peripherals 130 may have a monitor 132. The monitor 132 may collect power or energy consumption data from the peripheral 130 itself. In some embodiments, a bus 134 may have a monitor 136. The monitor 136 may be capable of determining the power or energy consumption for the bus 134 as a whole or for individual peripherals 130 attached to the bus 134.

Various network connections 138 may be part of the hardware components 104. The network connections 138 may allow the device 102 to connect to other devices either directly or through a network. Examples of network connections 138 may include various serial or parallel ports, Ethernet ports, wireless connections such as IEEE 802.11 (WiFi), IEEE 802.16 (WiMax), cellular telephone connections such as CDMA, TDMA, GSM, and other wireless connections.

In some cases, individual network connections 138 may have monitors 140 that are capable of measuring power. Such monitors 140 may be integral to the chipset or device that performs a network connection, for example. Some embodiments may have a separate monitor 142 that may monitor all of the network connections 138 separately to provide individual power or energy consumption information for each network connection 138, or may be capable of monitoring power or energy consumption for all or a group of network connections 138.

The hardware components 104 illustrated are an example of one embodiment of an instrumented hardware platform. In some embodiments, a subset of the components illustrated may actually be instrumented. The instrumentation may comprise hardware, firmware, or software components that monitor the power or energy consumed by a device. In some examples, the instrumentation may include hardware sensors that directly measure current draw or perform other physical measurements. In other examples, the instrumentation may estimate power or energy consumption based on various measurable criteria, such as temperature or other input. In such examples, a firmware or software component may estimate the power or energy consumption for the device.

The various monitors may be used by various software components 107 to determine energy consumption and calculate efficiencies for various workloads. The efficiencies may reflect a unit of work per unit of energy. In many cases, the hardware components 104 may be configured to execute a workload in different manners. By examining the efficiencies of several different system configurations, an efficient configuration may be used to perform the workload while minimizing energy consumption.

The software components 107 may include an operating system 144 that may include a monitoring API 146. The monitoring API 146 or Application Programming Interface may be a set of operating system level calls that allow a monitoring application 148 to request power or energy consumption information for one or more monitors.

The monitoring API 146 may perform low level communication with the various monitors to gather power or energy consumption information. By including the monitoring API 146 within the operating system 144, data collection from the various monitors could be performed faster and more reliably than if such calls were made through a monitoring application 148. The operating system level monitoring API 146 may support real time calls to the monitors, and may enable a call to a monitor to be coordinated with the execution of a specific workload or portion of a workload. In such embodiments, the operating system 144 may be able to both identify the workload and coordinate a call to a monitor using the monitoring API 146.

The monitor application 148 may perform calls to the monitoring API 146 and collect power or energy consumption data for a specific workload. In some embodiments, the monitoring application 148 may be a process that performs data collection and may consolidate collected data into a statistic, function, or other high level description of the efficiency of a monitored workload.

A workload manager 150 may manage workloads based on efficiency and may coordinate the evaluation of system configurations for efficiency. In one rule, the workload manager 150 may identify several different system configurations to evaluate, then perform evaluations of a workload on each of the system configurations. As the evaluations are performed, the results may be stored in a performance database 151. After performing the evaluations, an optimizer 152 may determine an optimized system configuration for the workload that may also be stored in the performance database 151.

In some cases, the workload manager 150 may be capable of switching the system configuration of an executing workload while the workload is operating. For example, the workload manager may change the affinity of a process thread from one processor core to another while the thread is executing. In making such a change, the power or energy consumption of the various processors may be evaluated to determine any changes in power or energy consumption. An example of such an operation may be illustrated by embodiment 300 presented later in this specification.

In managing workloads, the workload manager 150 may query the performance database 151 to determine an optimized system configuration for a specific workload, then launch the workload using the optimized system configuration. In such operations, the workload manager 150 may manage workloads so that those workloads are performed in the most efficient configuration based on data that may have been previously collected. An example of such an operation may be illustrated by embodiment 500 presented later in this specification.

The workload manager 150 may manage many different workloads, including applications 154, virtual applications 156, and virtual machines 158. In some cases, workloads may be managed separately or aggregated together as a single monitored workload. In some cases, the operating system may be considered a portion of a workload.

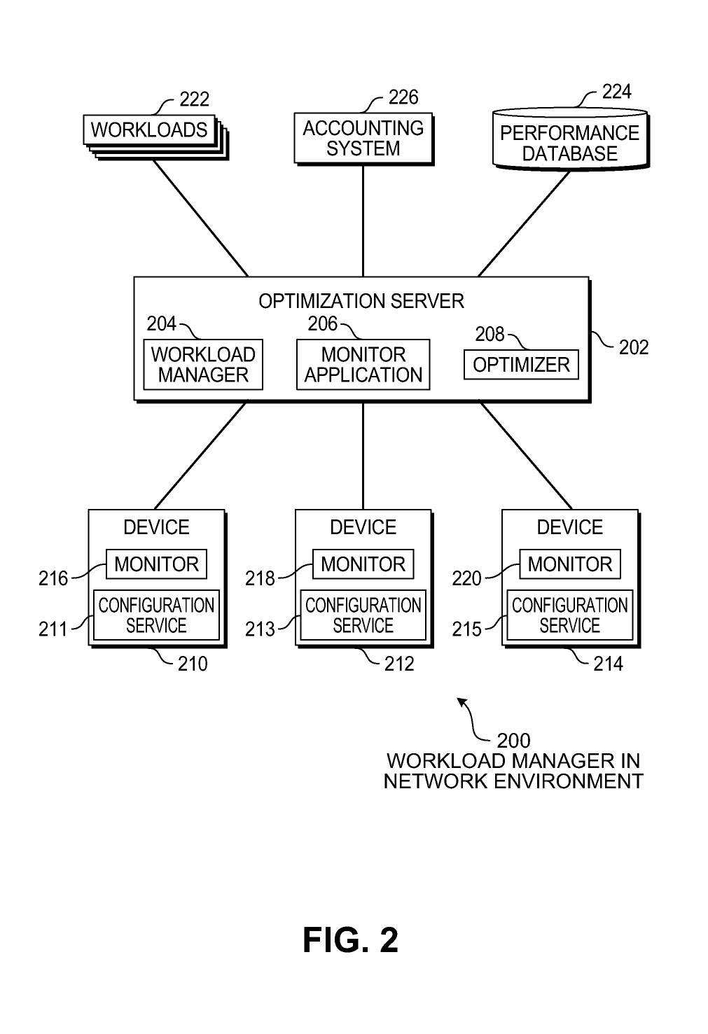

FIG. 2 is a diagram of an embodiment 200 showing a second system with a workload management system. Embodiment 200 is a simplified example of a system that may monitor hardware components for power or energy consumption and identify optimal system configurations using the power or energy consumption and may be operated in a datacenter environment.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning arbitrary long distances. Each embodiment may use different hardware, software, and interconnection architectures to achieve the functions described.

Embodiment 200 is an example of a system that may be deployed in a datacenter, where an optimization server 202 may manage workloads over many different devices. In many modern datacenters, workloads may be virtualized and may be able to be moved from one hardware platform to another. One use of virtualization technology may be to consolidate workloads to a small number of server computers when demand falls, and load balancing by moving some workloads to underutilized server computers when demand increases.

In embodiment 200, the optimization server 202 may be a system that manages various workloads 222 over many different devices. In the example of embodiment 200, workloads may be managed on devices 210, 212, and 214. In many datacenters, many hundreds or thousands of devices may be managed.

The optimization server 202 may include a workload manager 204, a monitor application 206, and an optimizer 208.

In general, the workload manager 204 may perform similar functions as the workload manager 150 of embodiment 100. The workload manager 204 may use power efficiency to identify an optimized system configuration for a specific workload.

In some embodiments, the workload manager 204 may evaluate different configurations of a single device. For example, the device 210 may be configurable so that a workload may be executed on a specific processor core or with certain memory devices. Another configuration of the device 210 may be to utilize two cores and a different memory device. By comparing the work performed per energy consumed, a measure of efficiency for each configuration may be determined.

The workload manager 204 may be capable of configuring a device in certain manners. For example, the workload manager 204 may work in conjunction with an application or service operating on the device 210 to configure the device 210, such as the configuration service 211, 213, and 215 illustrated on devices 210, 212, and 214, respectively. In such a use, the workload manager 204 may determine a configuration that contains various settings, and send the configuration to the configuration service 211 operating on device 210. The configuration service 211 may receive the configuration and apply the configuration when a specific workload is executed.

The configuration service 211 may be capable of changing various settings on the device 210. In some cases, the configuration service 211 may be capable of limiting operations of a workload to specific subsets of components on the device 210, and may be capable of turning off other components or causing unused components to operate in a low power mode. The configuration service 211 may be capable of setting affinity for a workload thread to specific processors or processor cores, directing memory or storage for a workload to specific memory or storage devices, or causing various peripherals to be used or not used by a workload.

The configuration service 211 may operate by interfacing with hardware or low level software, such as operating system level software, to make certain components and subcomponents available to a workload. In such a case, the device 210 may be configured such that the workload is not altered or changed. In such an embodiment, the configuration information may be sent to the device 210 separate from the workload, and the configuration information may be used to configure the device 210 prior to executing the workload. For example, the configuration settings may include operating system settings that may cause the workload to be executed with different efficiencies without having to change the workload in any way.

In another implementation, the workload manager 204 may operate by adding specific configuration information to a workload, where the workload may contain information that describes how the workload may be executed. When the workload is executed, the workload may request specific processors, memory devices, peripherals, or other configuration parameters. In such a case, the device 210 may execute a workload without using a configuration service 211.

In one such embodiment, the workload may be a virtual machine. Many virtual machine systems have a configurable virtual machine that is executed by a host device. The virtual machine may be configurable by allocating memory, processors, storage, peripherals, and network connections to the virtual machine. The software executed by the virtual machine may be stored in a virtual hard drive.

A workload manager 204 may configure a virtual machine workload by changing the memory, processors, storage, peripherals, and network connections. When the virtual machine is transferred to device 210, for example, the virtual machine may execute using the configuration defined by the workload manager 204.

While a device 210, 212, and 214 are executing, the monitors 216, 218, and 220, respectively, may monitor the power or energy consumption of various components and subcomponents. A monitor application 206 may communicate with the monitors 216, 218, and 220 to configure the monitors and receive power or energy consumption information.

The monitor application 206 may configure the monitors 216, 218, and 220 to define what information may be collected and when to collect the information. For example, the monitors may be configured to collect power or energy consumption information for a subset of the available components. The monitors may be configured to collect power or energy consumption information over a specific period of time, or when a specific workload performs a specific function, for example.

The monitor application 206 may receive data from the monitors 216, 218, and 220 in different manners. In some cases, the monitors may be configured to collect data for a specific workload and, when the workload is complete, send data to the monitor application 206. In other cases, the monitors may be configured to collect data and send data to the monitor application 206 at a predefined frequency or after a specific event occurs. For example, the monitors may be configured to transmit collected data every five minutes, or may be configured to transmit collected data after a certain portion of the workload has completed or when the power or energy consumption or activity exceeds a threshold.

In some embodiments, the monitors 216, 218, and 220 may be configured to transmit data to the monitor application 206. In such embodiments, the monitors may initiate the transmission of data. In other embodiments, the monitor application 206 may send a request to the monitors where the monitors respond to the request by transmitting data. In such embodiments, the requests may be sent to individual monitors or to groups of monitors.

The monitor application 206 may update a performance database 224 with historical data that describes the energy efficiency of a workload with its configuration. In some embodiments, the performance database 224 may be updated with a summary statistic that may be the overall energy efficiency of the workload in a specific system configuration. Other embodiments may include power or energy consumption for several monitored components as well as the specific system configuration.

The optimization server 202 may contain an optimizer 208 that may determine an optimized configuration based on historical data from a performance database 224. The optimized configuration may be stored in the performance database 224 and used by the workload manager 204 to configure a device or select a device for executing a workload.

The workloads 222 may be any software workload that may be executed on a device. Examples of workloads include the applications 154, virtual applications 156, and virtual machines 158 discussed in embodiment 100.

In some embodiments, an accounting system 226 may determine a monetary cost for executing a workload. The monetary cost may be determined in whole or in part by the energy consumption of a workload. In such embodiments, workloads that consume little energy may be charged less than workloads that consume larger amounts of energy. The energy consumption of each component and subcomponent may be charged at different rates and a total cost may be determined by summing the energy consumption of each component and subcomponent.

The accounting system 226 may identify which components are used to perform a workload. In such cases, the overall cost for performing a workload may be determined by applying a formula that determines a cost for each component based on the efficiency of the component, then summing the various component costs. In some embodiments, the cost for a component may be inversely proportional to the efficiency of the component for the workload. For example, a component that has poor efficiency for a given workload may be charged at a higher rate than a component that is operated at a higher efficiency for the workload. Such an example may encourage the development and deployment of workloads that maximize efficiency and reduce overall energy consumption.

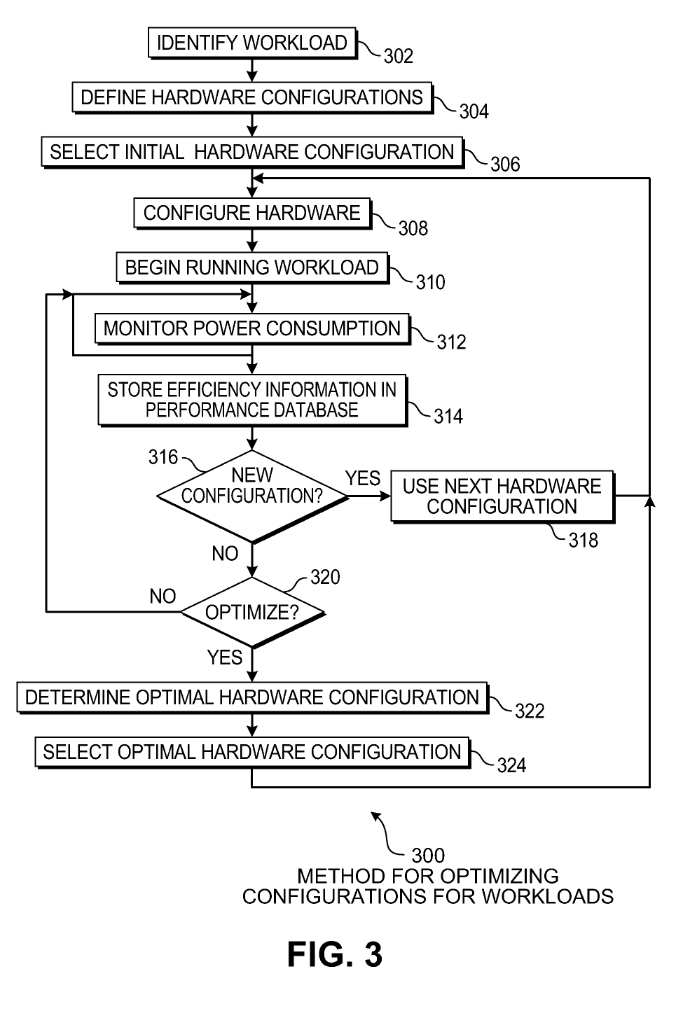

FIG. 3 is a flowchart illustration of an embodiment 300 showing a method for optimizing configurations for workloads. Embodiment 300 is an example of a process that may be performed by a workload manager, such as the workload manager 150 of embodiment 100 or the optimization server 202 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a method by which different system configurations may be evaluated in terms of the power or energy consumption for components and subcomponents of the hardware on which a workload may be executed. The general process may comprise defining several configurations to test, then executing a workload using the configurations. After collecting data while each configuration is executed, an optimized system configuration may be determined.

Embodiment 300 illustrates a method by which power or energy consumption for each system configuration is measured and an efficiency is determined from the energy consumption. In some embodiments, a baseline energy consumption may be determined without the workload, and any increase in power or energy consumption measured by the various components may be used to generate an expression that includes a baseline power or energy consumption plus a power or energy consumption due to the workload.

A baseline power or energy consumption may be used in different scenarios. In some embodiments, an existing workload may be operating on a system. The existing workload may be merely an operating system or other management software. In some cases, the existing workload may be a set of applications, virtual machines, or other workloads that may be executing at the same time as the monitored workload. In such cases, the monitoring may measure a delta or change in power or energy consumption due to the addition of the monitored workload.

In another scenario, the baseline power or energy consumption may be an idle or steady state power or energy consumption that a device may consume or maintain when no workloads are present.

In block 302, a workload may be identified. The workload may be any group of software components that may be executed by a processor and other hardware. Typically, a workload may be an application, virtual application, virtual machine, or other software component or group of software components. In some cases, the workload may include an operating system as well as several applications.

Various system configurations may be defined in block 304. In cases where the universe of different system configurations is limited, the system configurations in block 304 may be an exhaustive list of different configurations. For example, a single hardware platform may have a limited number of processor and memory combinations. In optimizing the system configuration, each combination of processor and memory combinations may be tested.

In some cases, the universe of system configurations may be very large. For example, a datacenter may have many hundreds or even thousands of system configurations and may maintain hundreds of different configurations of hardware, each of which may have different configurations available. In such an example, the system configurations in block 304 may be a limited to a number of typical system configurations or variations on previously tested and optimized system configurations.

An initial system configuration may be selected in block 306 and the hardware may be configured in block 308. The hardware may be configured in many different manners. In some cases, the hardware may be configured using operating system or low level configuration settings so that when the workload is executed, the workload will operate on the hardware as configured. Such a configuration may be set prior to executing the workload.

In some cases, the workload may be configured to use the hardware in a predefined way. In such cases, the workload may include a system configuration file or may include other settings that define how the workload will function on the hardware. An example above described how a virtual machine may be configured to operate in a certain manner by setting processors, memory, and other configurations prior to executing.

While the workload is running, power or energy consumption may be monitored in block 312. The monitoring may occur for individual components and subcomponents of the hardware, and a calculation may be performed to determine efficiency of the workload as a function of work per unit of energy. An example of a method for monitoring workload efficiency is presented in embodiment 400 later in this specification.

In some embodiments, the power or energy consumption may be monitored repeatedly or continually, as illustrated by the loopback arrow around block 312. In some such embodiments, the power or energy consumption may be measured at periodic intervals. In other embodiments, the power or energy consumption may be performed once and the process may proceed to block 314.

The efficiency information may be stored in a performance database in block 314. If a new configuration is to be evaluated in block 316, the next system configuration may be evaluated in block 318. If no other configurations are available in block 316, the process may return in block 320 to block 312 to continue executing.

If optimization is to be performed in block 320, an optimized system configuration may be determined in block 322. The optimized system configuration may be selected in block 324 and the process may return to block 308 to execute the workload. In such cases, the workload may operate continuously in the optimized system configuration.

In some embodiments, the process of embodiment 300 may be performed while a workload is executing. During execution, the system configuration may be changed by setting affinity of a processor thread to a specific processor, for example, or other changes that may be made during execution. In some cases, the workload may be briefly suspended while the system configuration is changed, then restarted. Such embodiments may include virtual machine embodiments where a virtual machine may be paused or suspended on one hardware platform, then transferred to another hardware platform to resume execution.

The optimization of block 322 may be any form of optimization. In some embodiments, the optimization may be simply selecting a system configuration from a set of previously evaluated system configurations based on the efficiency of the configurations.

The efficiency of a system configuration may be defined by a unit of work per unit of energy. In some cases, the optimization may be to optimize over the aggregated power or energy consumed by all measured components and subcomponents. In other cases, the optimization may evaluate each measured component and attempt to find a system configuration that uses as many components as optimally as possible.

In some embodiments, the optimization of block 322 may identify a system configuration that has not been previously evaluated or tested. In an example of such an embodiment, the optimization of block 322 may evaluate several previously tested system configurations and find an optimal combination of hardware components by evaluating each hardware component separately rather than as a group.

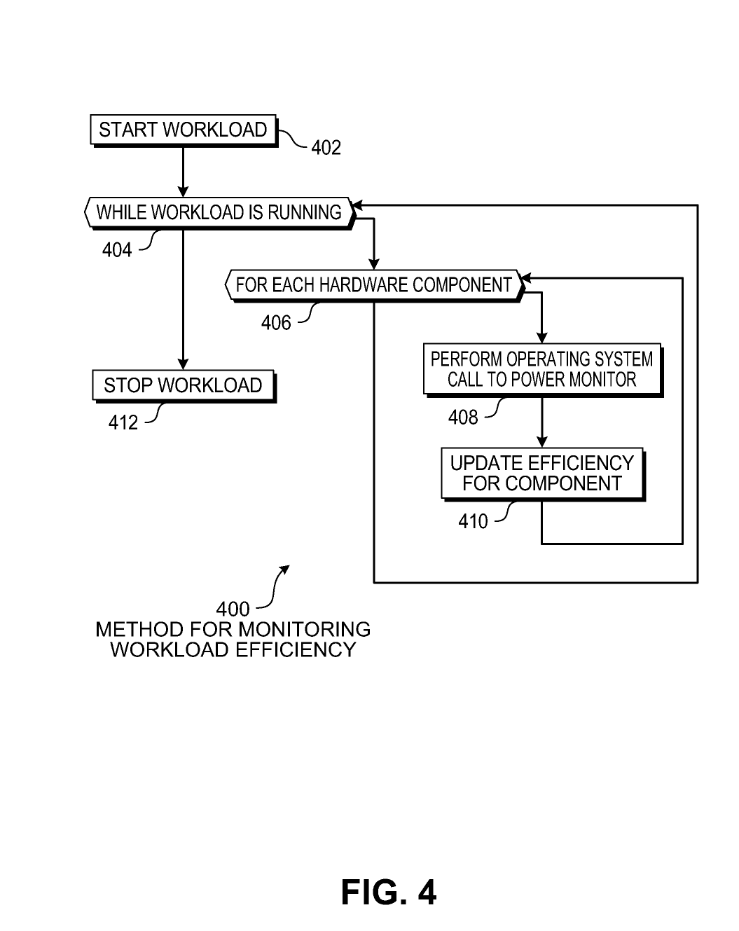

FIG. 4 is a flowchart illustration of an embodiment 400 showing a method for monitoring workload efficiency. Embodiment 400 is an example of a process that may be performed by block 312 of embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a process that may scan hardware components and update an efficiency expression for the hardware component. Embodiment 400 may continually scan the hardware components while a workload executes. Other embodiments may use other methods or sequences for collecting power consumption data and creating an efficiency expression.

The efficiency expression may define the efficiency of a workload in terms of work performed per unit of energy consumed. In many embodiments, the efficiency expression may be in the form of a separate efficiency for various components, where the overall efficiency may be the sum of several efficiencies for the components. In some embodiments, the efficiency expression may be a single number that expresses the overall efficiency.

A workload may be started in block 402 and while the workload is running in block 404, the components may be scanned for power or energy consumption.

For each hardware component in block 406, an operating system call may be made to a power monitor for the component in block 408. Using the results of the call in block 408, the efficiency for the component may be updated in block 410.

The process may scan all of the hardware components, then repeat until the workload is stopped in block 412.

In some embodiments, the efficiency of a hardware component may be expressed as a unit of work per unit of energy consumption. The expression of efficiency may reflect an average efficiency over a period of time. One manner for measuring an average efficiency is to monitor power energy for an extended time period, then divide the amount of work completed by the energy consumed for the period of time.

In some embodiments, peak efficiencies may be monitored. In one such embodiment, the loop of blocks 406 through 410 may be performed at predetermined intervals, such as every second, every five seconds, every hour, or some other interval. When a maximum or minimum efficiency is identified, the maximum or minimum may be stored in block 410 until another interval has a maximum or minimum that exceeds the previous maximum or minimum.

In some embodiments, the process of blocks 406 through 410 may be used to generate a timeline of work performed and energy consumed for each component. Such embodiments may be analyzed by reviewing the timeline to calculate maximum, minimum, and average efficiencies.

The expression of efficiency may be calculated in different manners and stored in different manners. In one example, a formula or expression for efficiency may include expressions for each measured component. In another example, a single summary statistic for efficiency may be used to express the work performed by the total energy consumed, where the total energy consumed is the sum of energy consumed for each component.

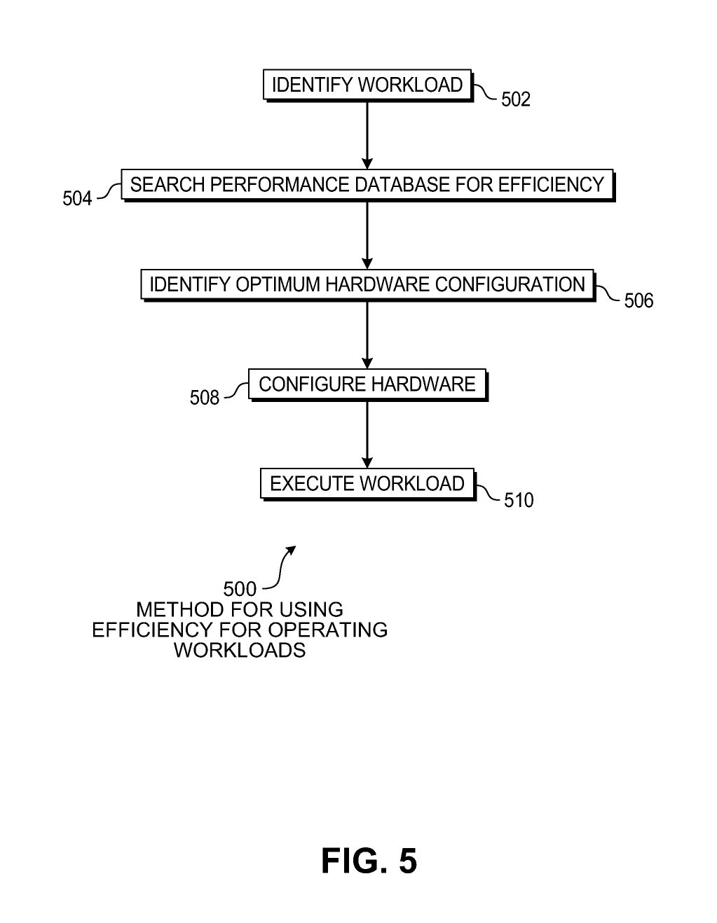

FIG. 5 is a flowchart illustration of an embodiment 500 showing a method for using efficiency for executing workloads. Embodiment 500 is an example of a process that may be performed by a workload manager 150 of embodiment 100 or the workload manager 204 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example of how the optimized system configuration determined in embodiment 300 may be used during operation of a workload.

In block 502, a workload may be identified. In block 504, a performance database may be searched to locate efficiency information for the workload. An optimum system configuration may be identified in block 506. The hardware may be configured in block 508 and executed in block 510.

In some cases, the performance database may contain raw historical information about power or energy consumed for work done while a workload is being performed. The optimum system configuration determined in block 506 may be determined by analyzing the historical information and determining an optimized system configuration.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
identifying a workload to be performed on a computing device;
defining a first system configuration for a first computing device;
executing said workload on said first system configuration;
monitoring power consumption of at least two hardware components during said executing; and
generating a first expression describing said energy efficiency for said workload for said first system configuration, said first expression comprising references to said at least two hardware components.

2. The method of claim 1 further comprising:
defining a second system configuration for said first computing device;
executing said workload on said second system configuration;
monitoring power consumption of said at least two hardware components during said executing on said second system configuration;
generating a second expression describing said energy usage for said workload in said second system configuration;
evaluating said first expression and said second expression to determine an efficient system configuration, and executing said workload on said efficient system configuration.

3. The method of claim 2, said first system configuration and said second system configuration being both different configurations of said first computing device.

4. The method of claim 3:
said first system configuration comprising a first thread configured to operate on a first processor;
said second system configuration comprising said first thread configured to operate on a second processor.

5. The method of claim 4, further comprising:
switching said workload from said first system configuration to said second system configuration while said workload is operational; and
switching said workload to said efficient system configuration while said workload is operational.

6. The method of claim 5, said efficient system configuration comprising a configuration of a first hardware component from said first system configuration and a configuration of a second hardware component from said second system configuration.

7. The method of claim 2, said second system configuration being on a second computing device.

8. The method of claim 1 further comprising:
identifying a baseline workload; and
executing said baseline workload on said first computing device in said first system configuration.

9. The method of claim 1 further comprising:
determining a cost to operate said workload based on said first expression.

10. The method of claim 9 further comprising:
identifying resources used by said workload and assigning a cost based on each of said resources.

11. A system comprising:
a monitoring application executing on a first computing device, said first computing device having energy usage instrumentation on a plurality of hardware components;
a workload manager configured to perform a method comprising:
identifying a workload to be performed on said first computing device;
defining a first system configuration for said first computing device;
executing said workload on said first system configuration;
monitoring energy consumption of at least two hardware components during said executing; and
generating a first expression describing energy efficiency for said workload for said first system configuration, said first expression comprising references to said at least two hardware components.

12. The system of claim 11, said workload manager being operated on said first computing device.

13. The system of claim 11, said workload manager being operated on a second computing device.

14. The system of claim 12, said workload manager being further configured to perform a second method comprising:
defining a second system configuration for a third computing device;
executing said workload on said second system configuration;
monitoring energy consumption of said at least two hardware components during said executing on said second system configuration;
generating a second expression describing energy efficiency for said workload in said second system configuration;
evaluating said first expression and said second expression to determine an efficient system configuration, and executing said workload on said efficient system configuration.

15. The system of claim 14, said workload being a virtual machine.

16. The system of claim 13, said monitoring being performed by a monitoring application on said first computing device, said generating a first expression being performed on said second computing device.

17. The system of claim 11, said power usage instrumentation being accessed through operating system level calls.

18. A method comprising:
identifying a workload to be performed on a computing device;
defining a first system configuration for a first computing device, said first system configuration comprising using a first processor for a first portion of said workload, said first computing device having a plurality of processors;
configuring said first workload to operate with said first system configuration, said configuring comprising identifying a first thread being comprised in said first portion of said workload and affinitizing said first thread to said first processor;
executing said workload using said first system configuration;
monitoring power consumption of said first processor and at least one other hardware component while said executing said workload, said monitoring being performed using an operating system level operation; and
generating an expression describing energy efficiency for said workload for said first system configuration, said expression comprising references to said first processor and said at least one other hardware component, said generating an expression being performed using an application level operation.

19. The method of claim 18, said plurality of processors being heterogeneous.

20. The method of claim 19, said generating an expression being performed on a second computing device.
